(19) United States
(12) Patent Application Publication
(10) Pub. No.: US 2021/0115703 A1
(43) Pub. Date: Apr. 22, 2021

(54) BUTTON-TYPE DUAL PADLOCK USING A BUTTON

(71) Applicant: FULLYEAR-BROTHER ENTERPRISE CO., LTD., Changhua County (TW)

(72) Inventor: Chun Te YU, CHANGHUA COUNTY (TW)

(21) Appl. No.: 16/699,298

(22) Filed: Nov. 29, 2019

(30) Foreign Application Priority Data
Oct. 21, 2019 (TW) 108137938

(51) Int. Cl. E05B 37/00; E05B 67/14; E05B 37/02

(52) U.S. Cl. CPC E05B 37/0034; E05B 37/025; E05B 37/0068; E05B 67/14

(57) ABSTRACT

A dual padlock includes a shell, a bolt, a button, a combination lock core, a key lock core, and a linking element supported on the shell. The key lock core is inserted in the button, rotatable relative to the button, and moveable linearly along the button. The linking element is moveable by the key lock core when the key lock core is rotated relative to the button and when the key lock core moves linearly with the button. The bolt is moved by the linking element when the linking element is moved. The bolt shuts the first opening of the shell when the bolt is in a closing position. The bolt opens the first opening of the shell when the bolt is in an opening position.

### BACKGROUND OF INVENTION

### 1. Field of Invention

The present invention relates to a padlock and, more particularly, to a button-type dual padlock that includes a key lock core and a combination lock core.

### 2. Related Prior Art

To cope with security check in the customs, dual padlocks have been devised. A typical dual padlock includes two lock cores, e.g., a key lock core and a combination lock core. The key lock core is intended to be operated by the customs. The combination lock core is intended to be operated by a user.

However, it is difficult to make some types of padlocks dual padlocks. For example, there are button-type padlocks as those disclosed in Taiwanese Patent Nos. 295997 and 295366. It is difficult to make a button-type lock a dual padlock. Button-type padlocks used to be popular for compactness and convenience, but they are getting less popular despite the compactness and convenience.

The present invention is therefore intended to obviate or at least alleviate the problems encountered in prior art.

### SUMMARY OF INVENTION

It is the primary objective of the present invention to provide a compact and convenient dual padlock.

To achieve the foregoing objective, the dual padlock includes a shell, a combination lock core, a button, a key lock core, a linking element and a bolt. The shell includes an upper portion, a lower portion, a corner in the vicinity of the lower portion, a cavity in the upper portion, a bore in the corner, and slots in the lower portion. The combination lock core is inserted in the shell and includes number wheels and a movable element that is moveable rectilinearly. Each of the number wheels includes a portion located out of the shell via a corresponding one of the slots. The movable element is allowed to move rectilinearly when a correct combination of numbers of the number wheels is dialed. The movable element is not allowed to move rectilinearly when the correct combination of numbers of the number wheels is not dialed. The button is connected to the movable element of the combination lock core and located out of the shell via the bore. The button is moveable rectilinearly only when the movable element is allowed to move rectilinearly. The key lock core is inserted in the button so that the key lock core is rotatable relative to the button and moveable rectilinearly with the button. The linking element is inserted in the shell, moved with the key lock core when the key lock core is rotated relative to the button, and moved by the key lock core when the key lock core is moved rectilinearly with the button. The bolt is supported on the shell and moved by the linking element between a closing position and an opening position when the linking element is moved. The bolt closes the cavity of the shell when the bolt is in the closing position. The bolt opens the cavity of the shell when the bolt is in the opening position.

In an aspect, the button includes a space for receiving the key lock core. The dent includes an upper open end and a lower open end. The key lock core includes a key hole in a lower portion and a boss on an upper portion. The key hole is accessible via the lower open end of the dent of the button. The boss is accessible via the upper open end of the dent of the button.

In another aspect, the linking element is moveable rectilinearly parallel to the movable element of the key lock core.

In another aspect, the bolt includes a block rotationally connected to the shell, a ring connected to the block, and a bar connected to the ring.

In another aspect, the linking element is moveable rectilinearly in the shell, and the linking element includes a first recess for receiving the block of the bolt and a second recess for receiving the boss of the key lock core.

In another aspect, the dual padlock further includes a spring compressed between the combination lock core and the button.

In another aspect, the linking element is located below the block of the bolt, and the button, the key lock core and the combination lock core are located below the linking element.

In another aspect, the button and the movable element of the combination lock core are made in one piece.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a button-type dual padlock according to the preferred embodiment of the present invention;

FIG. 2 is an exploded view of the button-type dual padlock shown in FIG. 1;

FIG. 3 is an enlarged perspective view of a linking element of the button-type dual padlock shown in FIG. 2;

FIG. 4 is a cross-sectional view of the button-type dual padlock shown in FIG. 1;

FIG. 5 is a cross-sectional view of the button-type dual padlock shown in FIG. 1, showing operation of a combination lock core; and

FIG. 6 is a cross-sectional view of the button-type dual padlock shown in FIG. 1, showing operation of a key lock core.

### DETAILED DESCRIPTION OF PREFERRED EMBODIMENT

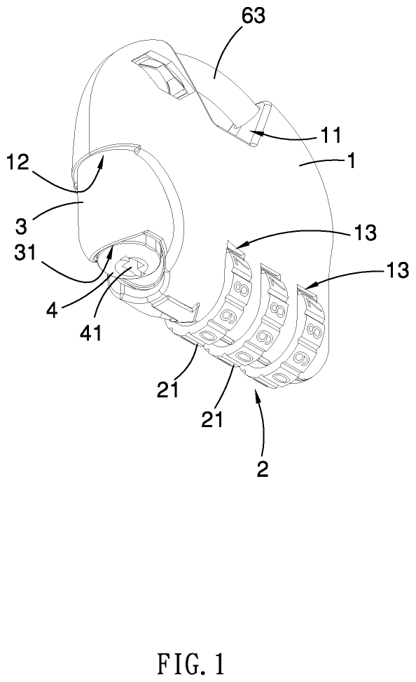

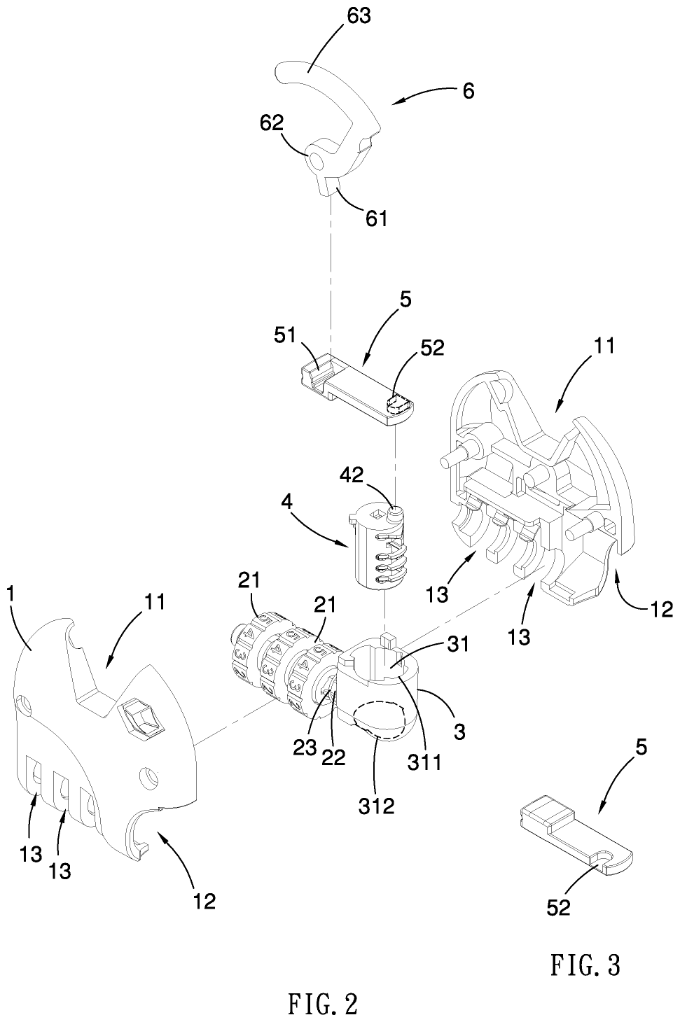

Referring to FIGS. 1 and 2, a button-type dual padlock includes a shell 1, a combination lock core 2, a button 3, a key lock core 4, a linking element 5 and a bolt 6 according to the preferred embodiment of the present invention. The shell 1 includes an upper portion and a lower portion. The lower portion of the shell 11 is formed with two corners. The shell 1 further includes a cavity 11 in the upper portion, a bore 12 in one of the corners, and slots 13 in the lower portion.

The combination lock core 2 is inserted in the shell 1, and includes several number wheels 21, a horizontally movable element 22 and a spring 23. Each of the number wheels 21 includes a portion exposed to the exterior of the shell 1 via a corresponding one of the slots 13. The movable element 22 is allowed to move horizontally when a correct combination of numbers of the number wheels 21 is dialed. The movable element 22 is prevented from the horizontal movement when the correct combination of numbers of the number wheels 21 is not dialed. The spring 23 is compressed between the button 3 and one of the number wheels 21 of the combination lock core 2.

The button 3 is connected to an end of the movable element 22 and includes a portion exposed to the exterior of the shell 1 via the bore 12. Preferably, the button 3 and the movable element 22 are made in one piece. The button 3 includes a space 31 that extends vertically. The space 31 includes an upper open end 311 and a lower open end 312.

The key lock core 4 is inserted in the space 31 of the button 3. The key lock core 4 is formed with a key hole 41 in a lower portion and a boss 42 on an upper portion. The key hole 41 is exposed to the exterior of the shell 1 via the lower open end 312 of the space 31 of the button 3. The boss 42 is exposed to the exterior of the shell 1 via the upper open end 311 of the space 31 of the button 3.

Referring to FIGS. 2 and 3, the linking element 5 is movably inserted in the shell 1. The linking element 5 includes a first recess 51 in an end and a second recess 52 in another end. The second recess 52 receives the boss 42 of the key lock core 4.

The bolt 6 is formed with a block 61 at an end, a ring 62 in the vicinity of the block 61, and a bar 63 at another end. The block 61 is inserted in the first recess 51 of the linking element 5. The ring 62 of the bolt 6 receives a pin (not numbered) that is inserted in the shell 1, thereby pivotally connecting the bolt 6 to the shell 1. The bar 63 includes an arched portion.

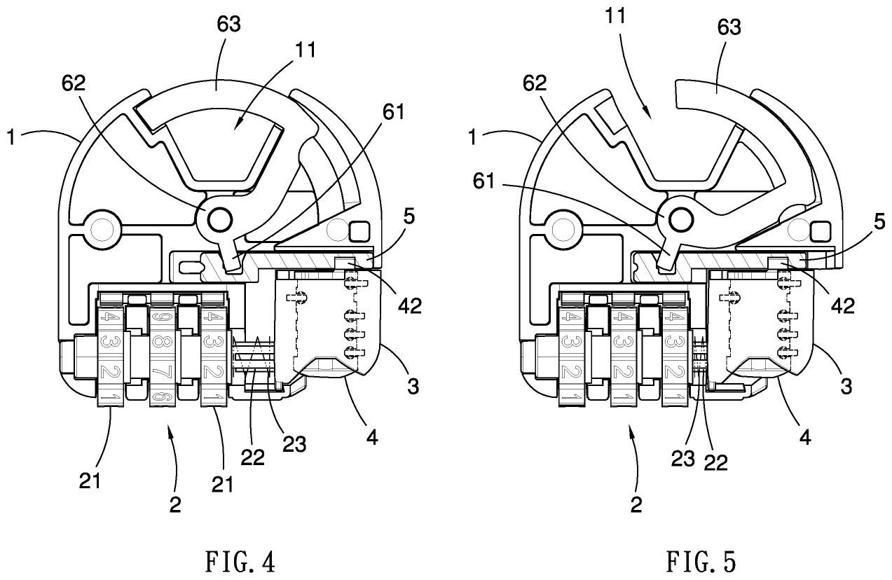

Referring to FIG. 4, the block 61 is in a first position. Thus, the bar 63 is in a closing position where the arched section of the bar 63 extends out of the shell 1 to close the cavity 11 of the shell 1. The correct combination of numbers of the number wheels 21 of the combination lock core 2 is not dialed so that the movable element 22 is not allowed to move rectilinearly. Thus, the button 3 cannot be pushed, i.e., the button-type dual padlock is in a locking position.

Referring to FIG. 5, once the correct combination of numbers of the number wheels 21 of the combination lock core 2 is dialed, the movable element 22 is allowed to move rectilinearly. Thus, the button 3 can be pushed. The boss 42 of the key lock core 4, which is inserted in the button 3, is rectilinearly moved with the button 3 to rectilinearly move the linking element 5. The rectilinear movement of the linking element 5 causes movement of the block 61. Then, the movement of the block 61 causes pivoting of the bolt 6 to a second position about the pin inserted in the ring 62. Thus, the bar 63 is pivoted to an opening position from the closing position about the pin inserted in the ring 62. Now, the arched section of the bar 63 opens the cavity 11 of the shell 1. That is, the button-type dual padlock is in an unlocking position.

Once the button 3 is released, the spring 23 is allowed to recover and hence push the button 3 back to the original position. The key lock core 4, which is formed with the boss 42, is synchronously returned to the original position. The linking element 5 is returned to the original position by the boss 42. Thus, the block 61 is returned to the first position from the second position, and the bar 63 is returned to the closing position from the opening position. In the above-described operation, the key lock core 4 is in a locking position.

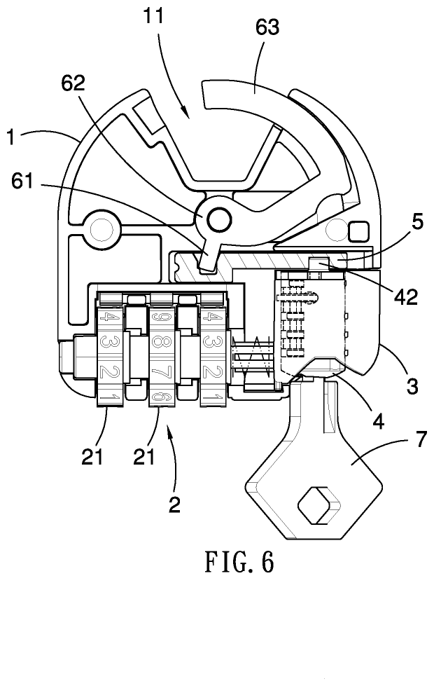

Referring to FIG. 6, the key lock core 4, which is formed with the boss 42, is moved to an unlocking position from the locking position as a correct key 7 is inserted in the key lock core 4 and turned in a sense of direction although the correct combination of numbers of the number wheels 21 of the combination lock core 2 is not dialed and the button 3 cannot be pushed. The boss 42 of the key lock core 4 rectilinearly moves the linking element 5. The linking element 5 moves the block 61, thereby pivoting the bolt 6 to the second position from the first position about the pin inserted in the ring 62. Thus, the bar 63 is pivoted to the opening position from the closing position about the pin inserted in the ring 62. Now, the arched section of the bar 63 opens the cavity 11 of the shell 1. That is, the button-type dual padlock is in another unlocking position.

When the key 7 is turned in an opposite sense of direction, the key lock core 4 is turned to the closing position from the locking position from the unlocking position. Now, the button-type dual padlock is back in the locking position shown in FIG. 4.

The button 3 can only be pushed when the movable element 22 of the combination lock core 2 is allowed to move rectilinearly. The key lock core 4 is rotationally inserted in the button 3 so that the key lock core 4 is rotatable relative to the button 3 and that the key lock core 4 is movable rectilinearly with the button 3. The linking element 5 is moved by the key lock core 4 when the key lock core 4 is rotated relative to the button 3. The bolt 6 is moved by the linking element 5. In the closing position, the bolt 6 closes the cavity 11 of the shell 1. In the opening position, the bolt 6 opens the cavity 11 of the shell 1. Advantageously, not only the key 7 can be used to move the button-type dual padlock between the locking and the unlocking position, but also the button 3 and the combination lock core 2 can be used to move the button-type dual padlock between the locking and the unlocking position. The button-type dual padlock allows an operation similar to the operation of button-type single padlocks. Hence, the button-type dual padlock solves the problems with the security check in the customs mentioned in RELATED PRIOR ART without causing troubles for users who are used to the button-type single padlocks. Furthermore, the shell 1 of the button-type dual padlock is similar to the shells of the button-type single padlock regarding shape and size.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A dual padlock comprising:
a shell (1) comprising an upper portion, a lower portion, a corner in the vicinity of the lower portion, a cavity (11) in the upper portion, a bore (12) in the corner, and slots (13) in the lower portion;
a combination lock core (2) inserted in the shell (1) and comprising number wheels (21) and a rectilinearly movable element (22), wherein each of the number wheels (21) includes a portion located out of the shell (1) via a corresponding of the slots (13), the movable element (22) is allowed to move rectilinearly when a correct combination of numbers of the number wheels (21) is dialed, and the movable element (22) is not allowed to move rectilinearly when the correct combination of numbers of the number wheels (21) is not dialed;
a button (3) connected to the movable element (22) of the combination lock core (2) and located out of the shell (1) via the bore (12), wherein the button (3) is moveable rectilinearly only when the movable element (22) is allowed to move rectilinearly;
a key lock core (4) inserted in the button (3) so that the key lock core (4) is rotatable relative to the button (3) and that the key lock core (4) is moveable rectilinearly with the button (3);
a linking element (5) inserted in the shell (1), moved with the key lock core (4) when the key lock core (4) is rotated relative to the button (3), and moved by the key lock core (4) when the key lock core (4) is moved rectilinearly with the button (3); and
a bolt (6) supported on the shell (1) and moved by the linking element (5) between a closing position and an opening position when the linking element (5) is moved, wherein the bolt (6) closes the cavity (11) of the shell (1) when the bolt (6) is in the closing position, and the bolt (6) opens the cavity (11) of the shell (1) when the bolt (6) is in the opening position.

2. The dual padlock according to claim 1, wherein the button (3) comprises a space (31) for receiving the key lock core (4), the space (31) comprises an upper open end (311) and a lower open end (312), the key lock core (4) comprises a key hole (41) in a lower portion and a boss (42) on an upper portion, the key hole (41) is accessible via the lower open end (312) of the space (31) of the button (3), and the boss (42) is accessible via the upper open end (311) of the space (31) of the button (3).

3. The dual padlock according to claim 1, wherein the movement of the linking element (5) is parallel to the movement of the movable element (22) of the combination lock core (2).

4. The dual padlock according to claim 1, wherein the bolt (6) comprises a block (61) rotationally connected to the shell (1), a ring (62) connected to the block (61), and a bar (63) connected to the ring (62).

5. The dual padlock according to claim 4, wherein the linking element (5) is moveable rectilinearly in the shell (1) and comprises a first recess (51) for receiving the block (61) of the bolt (6) and a second recess (52) for receiving the boss (42) of the key lock core (4).

6. The dual padlock according to claim 5, wherein the button (3) comprises a space (31) for receiving the key lock core (4), the space (31) comprises an upper open end (311) and a lower open end (312), the key lock core (4) comprises a key hole (41) in a lower portion and a boss (42) on an upper portion, the key hole (41) is accessible via the lower open end (312) of the space (31) of the button (3), and the boss (42) is accessible via the upper open end (311) of the space (31) of the button (3).

7. The dual padlock according to claim 6, wherein the bar (63) of the bolt (6) comprises an arched section that closes the cavity (11) of the shell (1) when the bolt (6) is in the closing position and opens the cavity (11) of the shell (1) when the bolt (6) is in the opening position.

8. The dual padlock according to claim 1, further comprising a spring (23) compressed between the combination lock core (2) and the button (3).

9. The dual padlock according to claim 1, wherein the linking element (5) is located below the block (61) of the bolt (6), and the button (3), the key lock core (4) and the combination lock core (2) are located below the linking element (5).

10. The dual padlock according to claim 1, wherein the button (3) and the movable element (22) of the combination lock core (2) are made in one piece.
